(19) United States
(12) Patent Application Publication
(10) Pub. No.: US 2022/0373142 A1
(43) Pub. Date: Nov. 24, 2022

(54) COLOR MIXING WITH TOTAL INTERNAL REFLECTOR AND RING REFLECTOR

(71) Applicant: SIGNIFY HOLDING B.V., EINDHOVEN (NL)

(72) Inventor: ERIC ANTHONY ROTH, BROOKLINE, NH (US)

(21) Appl. No.: 17/771,906

(22) PCT Filed: Oct. 23, 2020
(86) PCT No.: PCT/EP2020/079900

§ 371 Date: Apr. 26, 2022

Related U.S. Application Data
(60) Provisional application No. 62/926,598, filed on Oct. 28, 2019.

(30) Foreign Application Priority Data
Nov. 14, 2019 (EP) 19209157.7

(51) Int. Cl. F21K 9/62; G02B 19/00

(52) U.S. Cl. CPC F21K 9/62; G02B 19/0019; F21Y 2115/10

(57) ABSTRACT

A color mixing lens assembly is provided. The color mixing lens assembly may include an optic arranged about a light source and a ring reflector. The ring reflector may be arranged within the optic. In this configuration, the ring reflector is configured to reflect the first portion towards a surface of the optic. The optic may be configured to reflect the first portion through an exit plane of the optic, and to reflect a second portion of the electromagnetic radiation through the exit plane. Alternatively, the ring reflector may be arranged around the optic. The optic may further include a kick surface configured to reflect the first portion of the electromagnetic radiation toward the ring reflector. The ring reflector may be configured to reflect the first portion through an exit plane of the optic. The optic may be configured to reflect a second portion of the electromagnetic radiation through the exit plane.

### FIELD OF THE INVENTION

The present disclosure is directed generally to color mixing, specifically, a color mixing application within a Total Internal Reflector (TIR) optic utilizing a ring reflector.

### BACKGROUND

Color mixing of light typically involves a mixing chamber used to reflect or refract light generated by a light source with multiple color sources, and redistribute that light within the mixing chamber such that when the light leaves the mixing chamber, the rendered image of the light is substantially homogenous, i.e., does not include artifacts of multiple color sources from the light source. Typical color mixing chambers may be coupled with a Koehler integrator to evenly spread a given spectrum or source illumination over a field of view or image to mix the light. Other applications utilize mixing rods made of glass or silicone to mix light prior to allowing the light to proceed to a target for illumination. Both of these methods suffer from poor efficiency or poor near-field mixing.

### SUMMARY OF THE INVENTION

The present disclosure is directed to a color mixing assembly lens assembly and method of color mixing electromagnetic radiation using a ring reflector with a Total Internal Reflector (TIR) optic. The assembly splits received electromagnetic radiation into two portions before exiting the lens. A first portion of radiation is reflected twice; once by a ring reflector, and once by the TIR optic itself. A second portion of radiation is reflected only once, by the TIR optic itself. One benefit of the assembly discussed herein includes enhanced color mixing, as the dual reflected image produced by the first portion is a mirror image of the singularly reflected image produced by the second path.

Generally, in one aspect, a color mixing lens assembly is provided. The color mixing lens assembly may include at least one light source. The at least one light source may be arranged to produce a first electromagnetic radiation and a second electromagnetic radiation.

The color mixing lens assembly may further include an optic. The optic may be arranged about at least one light source. The optic may include a light source receiving structure. The light receiving structure may be configured to receive the first and second electromagnetic radiation from the at least one light source.

The color mixing lens assembly may further include a ring reflector. The ring reflector may be configured to reflect a first portion of the first and second electromagnetic radiation.

According to an example, the ring reflector may be arranged within the optic. The ring reflector is configured to reflect the first portion of the first and second electromagnetic radiation towards a surface of the optic. The optic may be configured to reflect the first portion of the first and second electromagnetic radiation through an exit plane of the optic. The optic may be further configured to reflect a second portion of the first and second electromagnetic radiation through the exit plane of the optic. The ring reflector may be arranged within the light source receiving structure.

According to an example, the ring reflector may be arranged around the optic. The optic may further include a kick surface. The kick surface may be configured to reflect the first portion of the first and second electromagnetic radiation toward the ring reflector. The kick surface may be conical. The ring reflector may be configured to reflect the first portion of the first and second electromagnetic radiation through an exit plane of the ring reflector. The optic may be configured to reflect a second portion of the first and second electromagnetic radiation through an exit plane of the optic.

According to an example, the ring reflector may include a plated surface. The plated surface may be configured to reflect the first portion of the first and second electromagnetic radiation.

According to an example, the ring reflector may be configured for total internal reflection to reflect the first portion of the first and second electromagnetic radiation. The ring reflector may be poly(methyl methacrylate) (PMMA). The ring reflector may be polycarbonate (PC).

According to an example, the ring reflector may include a tipped surface.

Generally, in another aspect, a method for color mixing using a color mixing lens assembly is provided. The method may include: (i) generating, via at least one radiation source, a first electromagnetic radiation and a second electromagnetic radiation; (ii) receiving, at a light source receiving structure of an optic, the first electromagnetic radiation and a second electromagnetic radiation from the at least one radiation source; (iii) reflecting, by a ring reflector, a first portion of the first and second electromagnetic radiation; and (iv) reflecting, by the optic, a second portion of the first and second electromagnetic radiation through the exit plane of the optic.

According to an example, the ring reflector may be arranged within the optic. In this example, the method for color mixing may further include reflecting, by the optic, the first portion of the first and second electromagnetic radiation through an exit plane of the optic. The first portion of the electromagnetic radiation is reflected by the optic after being initially reflected by the ring reflector.

According to an example, the ring reflector may be arranged around the optic and configured to reflect the first portion of the first and second electromagnetic radiation through an exit plane of the optic. In this example, the method for color mixing may further include reflecting, by a kick surface of the optic, the first portion of the first and second electromagnetic radiation toward the ring reflector. Following reflection by the kick surface, the first portion of the electromagnetic radiation is reflected by the ring reflector to mix with the light exiting the optic.

According to an example, the ring reflector may include a tipped surface.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is top-perspective schematic representation of a color mixing lens assembly with an interior ring reflector according to the present disclosure.

FIG. 2 is a side elevational view of the schematic representation of a color mixing lens assembly with an interior ring reflector according to the present disclosure.

FIG. 3 is an additional side elevational view of a schematic representation of a color mixing lens assembly with an interior ring reflector according to the present disclosure.

FIG. 4 is a side elevational view of a schematic representation of a color mixing lens assembly with an exterior ring reflector according to the present disclosure.

FIG. 5 is an additional side elevational view of a schematic representation of a color mixing lens assembly with an exterior ring reflector according to the present disclosure.

FIG. 6 is a flow chart illustrating the steps of a method according to the present disclosure.

FIG. 7 is a flow chart illustrating additional steps of a method according to the present disclosure.

### DETAILED DESCRIPTION OF EMBODIMENTS

The present disclosure is directed to a color mixing assembly lens assembly and method of color mixing electromagnetic radiation using a ring reflector with a Total Internal Reflector (TIR) optic. The assembly splits received electromagnetic radiation into two portions before exiting the lens. A first portion of radiation is reflected twice; once by the kick surface of the TIR optic, and once by a ring reflector. A second portion of radiation is reflected only once, by the TIR optic itself.

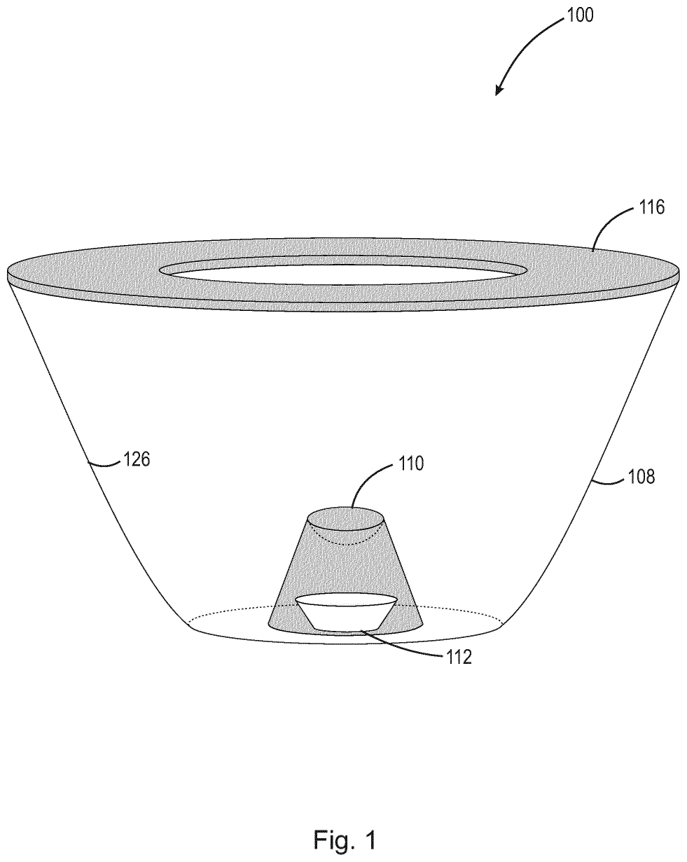

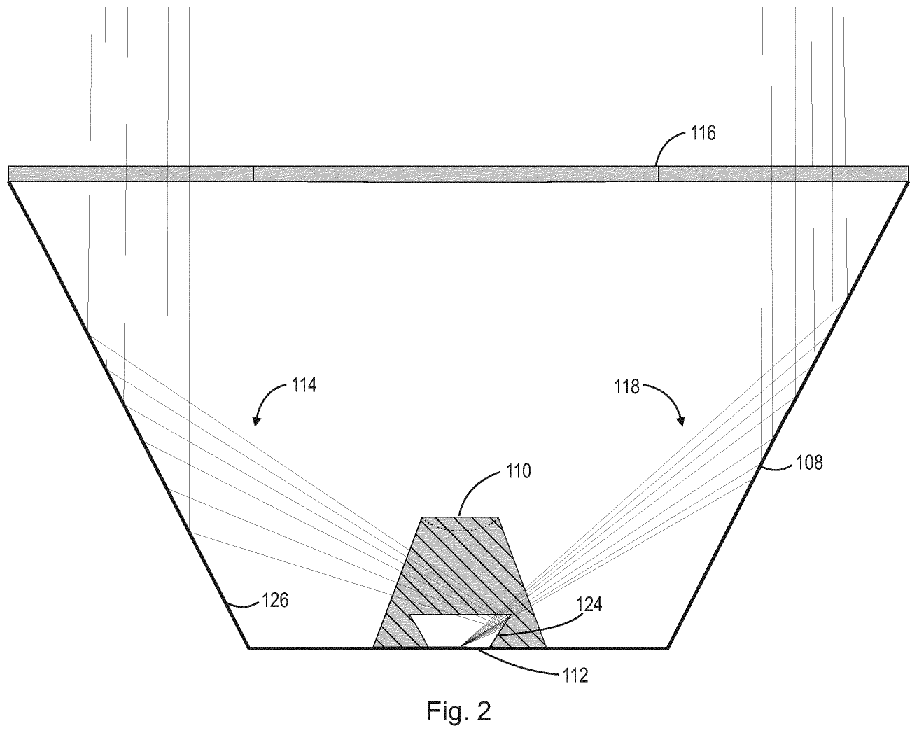

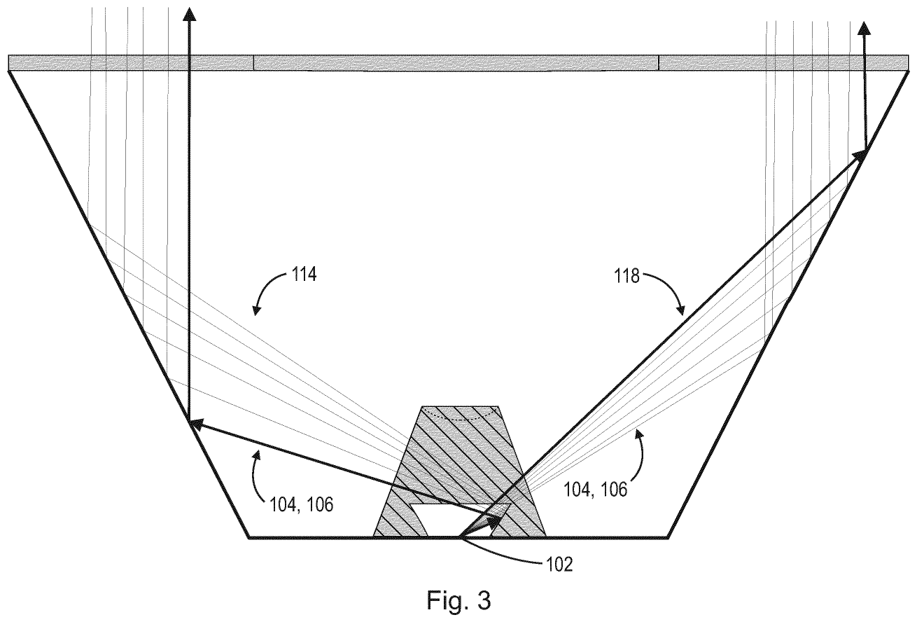

In one aspect, and with reference to FIGS. 1-3, a color mixing lens assembly 100 is provided. The color mixing lens assembly 100 may include at least one light source 102. The at least one light source 102 may be arranged to produce a first electromagnetic radiation 104 and a second electromagnetic radiation 106. The first electromagnetic radiation 104 may be visible light of a first color. The second electromagnetic radiation 106 may be visible light of a second color. For example, light source 102 may include two light emitting diodes (LEDs), where one LED produces visible blue light, and another LED produces visible red light. In another example, the light source 102 may include an array of four LEDs producing green, white, blue, and red light. A person having ordinary skill in art would appreciate that any combination of colored LEDs may be used. In a further example, the light source 102 may be a white light LED having a broad color variation spectrum corresponding to the output angle of the light. As described below, the color mixing assembly 100 is configured to blend the light emitted by the LEDs such that the light source 102 as a whole appears to emit light of a single color.

The color mixing lens assembly 100 may further include an optic 108. The optic 108 may be configured as a TIR optic. The optic 108 may be frustoconical or any other shape designed to facilitate total internal reflection of electromagnetic radiation incident to its interior surface. In one example, the optic 108 may be poly(methyl methacrylate) (PMMA) or polycarbonate (PC). In another example, the optic 108 may be silicone or glass. The optic 108 may be any material with a refractive index sufficient for total internal reflection when the optic is placed in air. The surface of the optic 108 may be a freeform surface designed via computer simulation.

The optic 108 may be arranged about at least one light source 102. The optic 108 may include a light source receiving structure 110. The light source receiving structure 110 may be configured to receive the first and second electromagnetic radiation 104, 106 from the at least one light source 102. The light source receiving structure 110 may be frustoconical. The light source receiving structure 110 may be dome-shaped. The interior surface of the light receiving structure 110 may be flat. The interior surface of the light receiving structure 110 may be parabolic. The light source receiving structure 110 may be concentric relative to the optic 108.

The color mixing lens assembly 100 may further include a ring reflector 112. The assembly 100 utilizes the ring reflector 112 to reflect a first portion 114 of electromagnetic radiation 104, 106 twice; once by the ring reflector 112, and once by the optic itself 108. A second portion 118 of radiation 104, 106 is reflected only once, by the TIR optic 108. The present disclosure provides two examples of ring reflector 112 arrangements; (1) within the optic 108 and (2) around the optic 108.

According to an example, and as shown in FIGS. 1-3, the ring reflector 112 may be arranged within the optic 108. The ring reflector 112 may be configured to reflect the first portion 114 of the first and second electromagnetic radiation 104, 106 towards a surface 126 of the optic 108. The first portion 114 may be considered to be analogous to a first path of electromagnetic radiation 104, 106. The optic 108 may be configured to reflect the first portion 114 of the first and second electromagnetic radiation 104, 106 through an exit plane 116 of the optic 108. The optic 108 may be further configured to reflect a second portion 118 of the first and second electromagnetic radiation 104, 106 through the exit plane 116 of the optic 108. The second portion 118 may be considered to be analogous to a second path of electromagnetic radiation 104, 106. The ring reflector 112 may be arranged within the light source receiving structure 110. The surface of the optic 108 may be plated when the ring reflector is arranged within the optic 108.

As shown in FIGS. 1-3, the light source 102 and ring reflector 112 are arranged inside the light source receiving structure 110. A first portion 114 of the electromagnetic radiation 104, 106 is reflected by the ring reflector 112 towards the surface of the optic 108. The surface 126 of the optic 108 then reflects the first portion 114 of the electromagnetic radiation 104, 106 though the exit plane 116 of the optic 108. Thus, the first portion 114 of radiation is reflected twice before exiting the optic 108. A second portion 118 of radiation 104, 106 is reflected a single time, by the surface 126 of the optic 108, before exiting the optic 108. The first portion 114 of twice-reflected radiation 104, 106 appears as the mirror image of the single-reflected second portion 118.

In the above configuration, the ring reflector 112 may have a tipped surface 124 configured to reflect the first portion 114 of radiation 104, 106 towards the surface 126 of the optic 108. An example of an interior ring reflector 112 with a tipped surface 124 is shown in FIGS. 1-3. The angle of the tipped surface 124 may be chosen such that the flux of the first portion 114 and second portion 118 exiting the optic 108 are roughly equal for optimized color mixing.

In a preferred example, the first portion 114 and second 118 portion of the electromagnetic radiation 104, 106 may exit the optic 108 at an approximately equal angle. This preferred example may be achieved by implementing a slight tip to a base surface of the light source receiving structure 110 within the optic 108. In this configuration, instead of collimating the electromagnetic radiation 104, 106 from the light source receiving structure 110, the radiation 104, 106 may be slightly divergent. This divergence results in the radiation 104, 106 appearing to be defocused. Accordingly, to achieve collimation of both first 114 and second 118 radiation portions, the angle of tipped surface 124 of the ring reflector 112 may be approximately twice as large as the angle of the tipped base of the light source receiving structure 110.

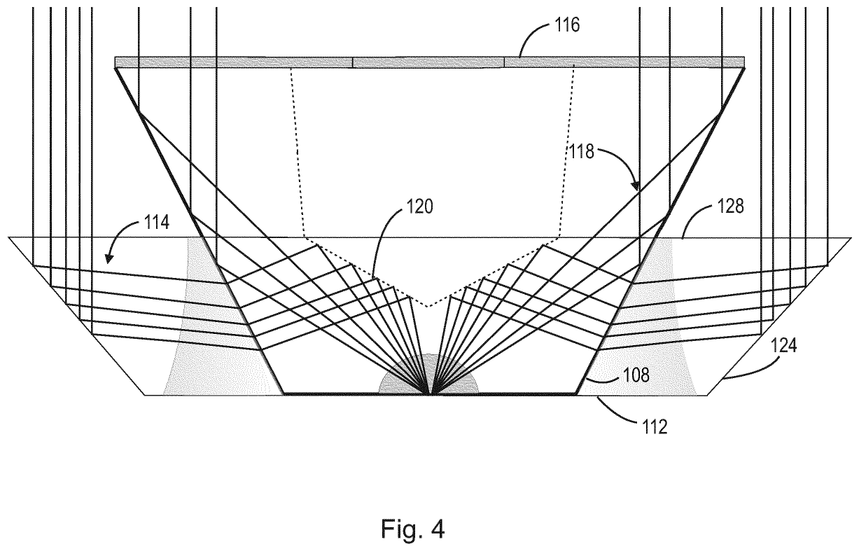

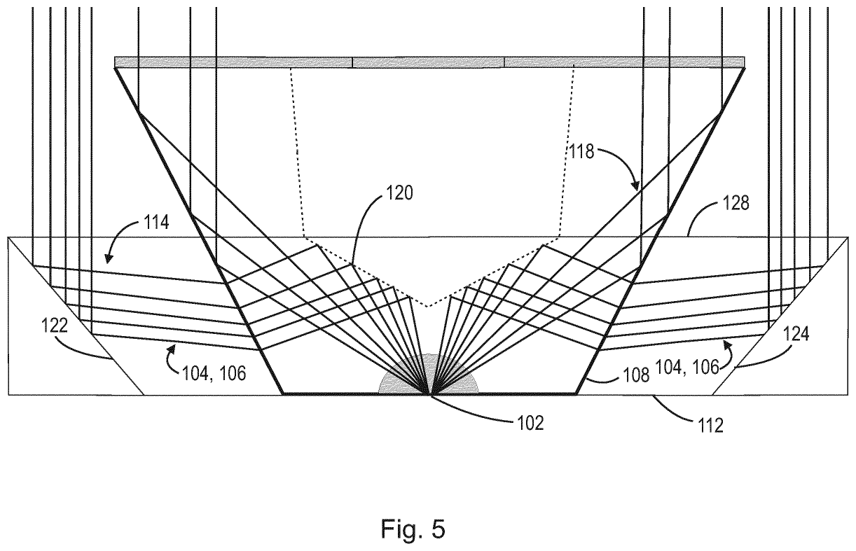

According to an alternative example, and as shown in FIGS. 4 and 5, the ring reflector 112 may be arranged around the optic 108. Placing the ring reflector 112 around the optic 108 allows for the overall lens assembly 100 to be shorter than the interior ring reflector arrangement. The optic 108 may further include a kick surface 120. The kick surface 120 may be configured to reflect the first portion 114 of the first and second electromagnetic radiation 104, 106 toward the external ring reflector 112. The kick surface 120 may be conical. Alternatively, the kick surface 120 may be any other shape suitable to reflect the first portion 114 of the radiation 104, 106 towards the external ring reflector 112. In a preferred embodiment, the kick surface 120 may be configured to reflect about 50% of the total flux of the electromagnetic radiation 104, 106 toward the ring reflector 112 for optimized color mixing. Following reflection from the ring reflector 112, the first portion 114 of electromagnetic radiation 104, 106 may exit the optic 108 through its angled side. The first portion 114 of electromagnetic radiation may be refracted upon exiting the optic 108, as shown in FIGS. 4 and 5.

The ring reflector 112 may be configured to reflect the first portion 114 of the first and second electromagnetic radiation 104, 106 through an exit plane 128 of the ring reflector 112. According to an example, and as shown in FIG. 5, the ring reflector 112 may include a plated surface 122. The plated surface 122 may be configured to reflect the first portion 114 of the first and second electromagnetic radiation 104, 106. The plated surface 122 may be a metallized mirror surface. Alternatively, the plated surface may be any specular coating and/or layer

According to a further example, and as shown in FIG. 4, ring reflector 122 may be configured for TIR to reflect the first portion of the first and second electromagnetic radiation. To achieve TIR, the surface of the ring reflector 122 may be a freeform surface designed via computer simulation. The ring reflector 122 may be PMMA. The ring reflector 122 may be PC. The ring reflector 122 may include a tipped surface 124.

The optic 108 may be configured to reflect a second portion 118 of the first and second electromagnetic radiation 104, 106 through the exit plane 116 of the optic 108. Thus, the while the first portion 114 of radiation is reflected twice before exiting the optic 108, the second portion 118 of radiation 104, 106 is reflected a single time. The first portion 114 of twice-reflected radiation 104, 106 appears as the mirror image of the single-reflected second portion 118. Upon exiting the optic 108, the first portion 114 and second portion 118 of electromagnetic radiation 104, 106 should be collimated without becoming defocus.

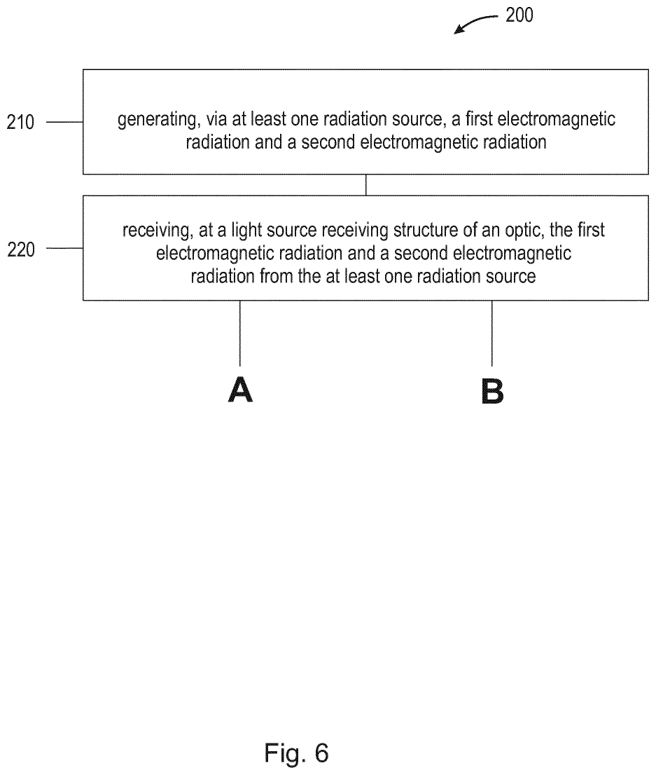

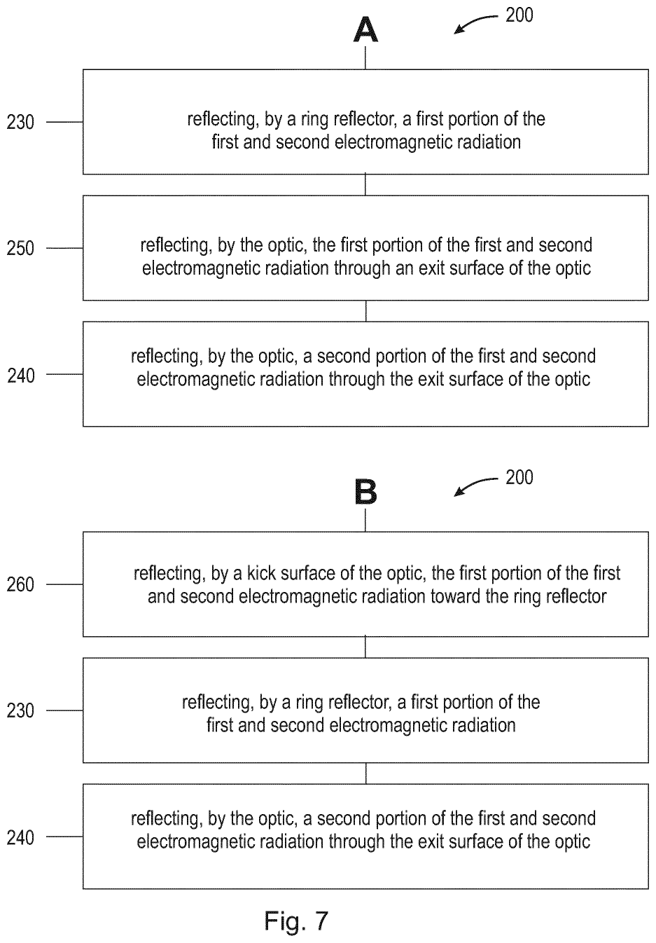

Generally, in another aspect, and as shown in FIGS. 6 and 7, a method 200 for color mixing using a color mixing lens assembly is provided. The method 200 may include: (i) generating 210, via at least one radiation source, a first electromagnetic radiation and a second electromagnetic radiation; (ii) receiving 220, at a light source receiving structure of an optic, the first electromagnetic radiation and a second electromagnetic radiation from the at least one radiation source; (iii) reflecting 230, by a ring reflector, a first portion of the first and second electromagnetic radiation; and (iv) reflecting 240, by the optic, a second portion of the first and second electromagnetic radiation through the exit plane of the optic. The ring reflector may include a tipped surface.

According to an example, the ring reflector may be arranged within the optic. In this example, the method 200 for color mixing may further include reflecting 250, by the optic, the first portion of the first and second electromagnetic radiation through an exit plane of the optic. The first portion of the electromagnetic radiation is reflected by the optic after being initially reflected by the ring reflector.

According to an example, the ring reflector may be arranged around the optic and configured to reflect the first portion of the first and second electromagnetic radiation through an exit plane of the ring reflector. In this example, the method for color mixing may further include reflecting 260, by a kick surface of the optic, the first portion of the first and second electromagnetic radiation toward the ring reflector. Following reflection by the kick surface, the first portion of the electromagnetic radiation is reflected by the ring reflector to mix with the light exiting the optic.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. As used herein in the specification and in the claims, “or” should be understood to have the same meaning as “and/or” as defined above.

It should also be understood that, unless clearly indicated to the contrary, in any methods claimed herein that include more than one step or act, the order of the steps or acts of the method is not necessarily limited to the order in which the steps or acts of the method are recited.

1. A color mixing lens assembly comprising:
at least one light source arranged to produce a first electromagnetic radiation and a second electromagnetic radiation;
an optic arranged about the at least one light source, the optic comprising a light source receiving structure configured to receive the first and second electromagnetic radiation from the at least one light source; and
a ring reflector configured to reflect a first portion of the first and second electromagnetic radiation,
wherein the ring reflector is configured to only once reflect the first portion of the first and second electromagnetic radiation towards a surface of the optic, and
wherein the optic is configured to only once reflect the first portion of the first and second electromagnetic radiation through an exit plane of the optic, and to only once reflect a second portion of the first and second electromagnetic radiation through the exit plane of the optic.

2. The color mixing lens assembly of claim 1, wherein:
the ring reflector is arranged within the optic.

3. The color mixing lens assembly of claim 2, wherein the ring reflector is arranged within the light source receiving structure.

4. A color mixing lens assembly comprising:
at least one light source arranged to produce a first electromagnetic radiation and a second electromagnetic radiation;
an optic arranged about the at least one light source, the optic comprising a light source receiving structure configured to receive the first and second electromagnetic radiation from the at least one light source; and
a ring reflector configured to reflect a first portion of the first and second electromagnetic radiation;
wherein, the ring reflector is arranged around the optic;
the optic further comprises a kick surface configured to reflect the first portion of the first and second electromagnetic radiation toward the ring reflector;
the ring reflector is configured to only once reflect the first portion of the first and second electromagnetic radiation through an exit plane of the ring reflector; and
the optic is configured to only once reflect a second portion of the first and second electromagnetic radiation through an exit plane of the optic.

5. The color mixing lens assembly of claim 4, wherein the ring reflector comprises a plated surface to reflect the first portion of the first and second electromagnetic radiation.

6. The color mixing lens assembly of claim 4, wherein the ring reflector is configured for total internal reflection to reflect the first portion of the first and second electromagnetic radiation.

7. The color mixing lens assembly of claim 6, wherein the ring reflector is poly(methyl methacrylate) (PMMA).

8. The color mixing lens assembly of claim 1, wherein the ring reflector comprises a tipped surface.

9. The color mixing assembly of claim 4, wherein the kick surface is conical.

10. A method for color mixing using a color mixing lens assembly, the method comprising:
generating, via at least one radiation source, a first electromagnetic radiation and a second electromagnetic radiation;
receiving, at a light source receiving structure of an optic, the first electromagnetic radiation and a second electromagnetic radiation from the at least one radiation source;
reflecting, by a ring reflector, a first portion of the first and second electromagnetic radiation only once toward a surface of the optic; and
reflecting, by the optic, the first portion and a second portion of the first and second electromagnetic radiation only once through the exit plane of the optic.

11. The method of color mixing of claim 10, wherein the ring reflector is arranged within the optic.

12. The method for color mixing of claim 10, wherein the ring reflector is arranged around the optic and configured to reflect the first portion of the first and second electromagnetic radiation through an exit plane of the optic.

13. The method for color mixing of claim 12, further comprising reflecting, by a kick surface of the optic, the first portion of the first and second electromagnetic radiation toward the ring reflector.

14. The method for color mixing of claim 10, wherein the ring reflector comprises a tipped surface.
